(19) United States
(12) Patent Application Publication
(10) Pub. No.: US 2013/0057957 A1
(43) Pub. Date: Mar. 7, 2013

(54) LENS MODULE WITH ANTI-REFLECTION FILM

(71) Applicant: TSUNG-YU LIN, Tu-Cheng (TW)

(72) Inventor: TSUNG-YU LIN, Tu-Cheng (TW)

(73) Assignee: HON HAI PRECISION INDUSTRY CO., LTD., Tu-Cheng (TW)

(21) Appl. No.: 13/340,609

(22) Filed: Dec. 29, 2011

(30) Foreign Application Priority Data
Sep. 6, 2011 (TW) 100132141

(51) Int. Cl. G02B 1/11; G02B 7/02

(52) U.S. Cl. 359/601

(57) ABSTRACT

A lens module includes a lens barrel, a first lens, a second lens, a third lens, and two spacers. The lens barrel includes an object-side end and an image-side end. The first, second, and third lenses are received in the lens barrel and arranged in that order from the object-side to the image-side. The second lens includes an object-side surface facing the object-side end and an image-side surface facing the image side end. An anti-reflection film is coated on the image-side surface of the second lens. The reflectance of the anti-reflection film to light rays having wavelength in a range from about 700 nm to about 740 nm is lower than about 2.25%.

### BACKGROUND

1. Technical Field

The present disclosure relates to lens modules and, particularly, to a lens module with an anti-reflection film.

2. Description of Related Art

In related art, a lens module includes a lens barrel and at least one lens received in the lens barrel for focusing or diffusing light rays projected thereon. However, the at least one lens cannot transmit 100% visible light rays and reflect a minority of visible light rays, especially light rays at wavelength from about 700 nm to about 740 nm, which form a glare in an image after multiple reflections.

Therefore, it is desirable to provide a lens module, which can overcome the limitations described.

### BRIEF DESCRIPTION OF THE DRAWINGS

FIG. 1 is a cross-sectional schematic view of a lens module of an exemplary embodiment.

FIG. 2 is a cross-sectional view of a spacer of the lens module of FIG. 1.

FIG. 3 is a partial, cross-sectional view of an anti-reflection film of the lens module of FIG. 1.

### DETAILED DESCRIPTION

Embodiments of the disclosure will now be described in detail, with reference to the accompanying drawings.

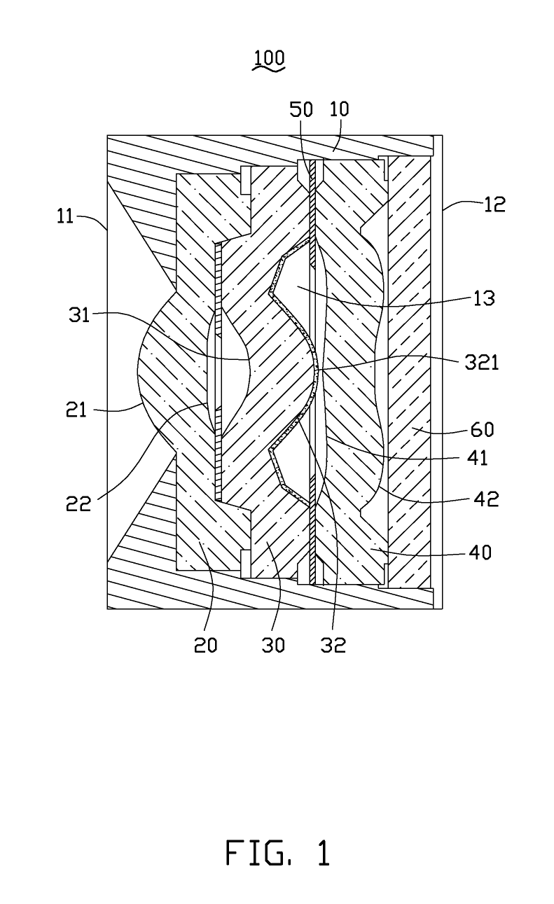

Referring to FIG. 1, a lens module 100, according to an exemplary embodiment, includes a lens barrel 10, a first lens 20, a second lens 30, a third lens 40, two spacers 50, and a filter glass 60.

The lens barrel 10 is tubular and includes an object-side end 11 and an image-side end 12 opposite to the object-side end 11. The lens barrel 10 defines a receiving room 13 extending through the object-side end 11 and the image-side end 12. In this embodiment, the lens barrel 10 is made of light-shielding/opaque/black material(s).

The first lens 20 is received in the receiving room 13, adjacent to the object-side end 11. The first lens 20 includes a convex object-side surface 21 facing the object-side end 11 and a concave image-side surface 22 facing the image-side end 12.

The second lens 30 is received in the receiving room 13 between the first lens 20 and the third lens 40. The second lens 30 includes a concave object-side surface 31 facing the object-side end 11 and a convex image-side surface 32 facing the image-side end 12.

The third lens 40 is received in the receiving room 13, adjacent to the image-side end 12. The third lens 40 includes a convex object-side surface 41 facing the object-side end 11 and a concave image-side surface 42 facing the image-side end 12.

In this embodiment, the first lens 20, the second lens 30, and the third lens 40 are made of glass or plastic, and may be spherical or aspheric lenses. In other embodiments, other lenses can be included and arranged at appropriate positions at the two sides of the first lens 20 and the third lens 40.

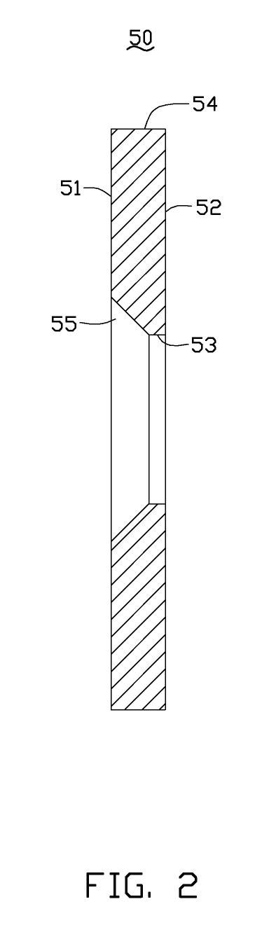

Referring to FIG. 2, each of the spacers 50 is an annular plate and made of light-shielding/opaque/dark material(s). The spacers 50 are received in the receiving room 13, and are positioned between the first lens 20 and the second lens 30, and between the second lens 30 and the third lens 40. Each spacer 50 includes an object-side surface 51, an image-side surface 52, a cylindrical inner sidewall 53, and a cylindrical outer sidewall 54. The object-side surface 51 faces the object-side end 11 of the lens module 10, and the image-side surface 52 faces the image-side end 12. The inner sidewall 53 and the outer sidewall 54 are parallel with an optical axis L of the lens module 100.

The intersection of the object-side surface 51 and the inner surface 53 form a chamfer 55. In this embodiment, the chamfer 55 is beveled. An included angle is formed between the chamfer 55 and the optical axis L of the lens module 100. The included angle is open toward the object-side end 11 and is larger than about 30 degrees but less than about 60 degrees.

The filter glass 60 is a plate, and received in the receiving room 13 for covering the image-side end 12 of the lens barrel 10. The filter glass 60 filters or absorbs infrared light from the light rays penetrating to the third lens 40.

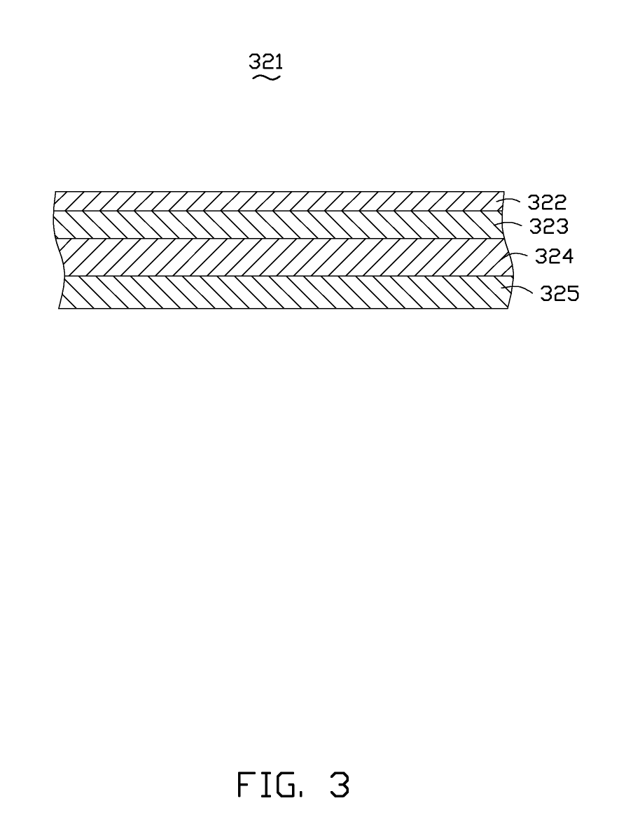

Referring to FIG. 3, an anti-reflection film 321 is coated on the image-side surface 32 of the second lens 30. The reflectance of the anti-reflection film 321 to light rays having wavelength in a range from about 700 nm to about 740 nm is lower than about 2.25%. In this embodiment, the anti-reflection film 321 includes first to fourth layers 322, 323, 324, 325 orderly stacked on the image-side surface 32. The odd numbered layers of the anti-reflection film 321 are made from titanium dioxide (TiO₂) and the even numbered layers of the anti-reflection film 321 are made from silicon dioxide (SiO₂). The material and thickness of each layer of the anti-reflection film 32 are shown in Table 1.

TABLE 1

| Layers | Material | Thickness(nm) |
|---|---|---|
| First layer | TiO₂ | 11.52 |
| Second layer | SiO₂ | 28.93 |
| Third layer | TiO₂ | 111.15 |
| Fourth layer | SiO₂ | 83.78 |

It should to be understood, the anti-reflection film 32 can be stacked by any number of layers with other materials for anti-reflecting light rays projected thereon. The reflectance of the anti-reflection film 321 is generally lower than about 2%, such as anti-reflection film 321 shown in Table 1.

In use, light rays enter into the lens module 100 from the object-side end 11 of the lens barrel 10 and strike the first lens 20. The light rays penetrating the first lens 20 strike the second lens 30, incidence angles of the light rays projecting on the image-side surface 32 are lower than 6.85 degrees. As the incidence angles of the light rays is far lower than a critical angle of the image-side surface 32, the reflectance of the image-side surface 32 to the light rays is decreased. In addition, as the anti-reflection film 321 coated on the image-side surface 32 increases transmittance and decreases reflectance, the reflectance of the anti-reflection film 321 to the light rays at wavelength from about 700 nm to about 740 nm is lower than about 2.25%. Furthermore, as the chamfer 55 of the spacer 50 faces the object-side end 11, the light rays striking the chamfer 55 will not be reflected from the chamfer 55 onto the second lens 30 or the third lens 40.

Comparing images captured by the lens module 100 of this embodiment with images captured by traditional lens module, the light rays can form images having less glare, and the quality of the images is enhanced.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A lens module, comprising:
a lens barrel comprising an object-side end and an image-side end opposite to the object-side end;
a first, a second, and a third lenses received in the lens barrel and arranged in this order from the object-side end to the image-side end, the second lens comprising an object-side surface facing the object-side end and an image-side surface facing the image side end; and
an anti-reflection film coated on the image-side surface of the second lens, wherein the reflectance of the anti-reflection film to light rays having wavelength in a range from about 700 nm to about 740 nm is lower than about 2.25%.

2. The lens module of claim 1, wherein the object-side surface of the second lens is a concave surface, and the image-side surface of the second lens is a convex surface.

3. The lens module of claim 1, wherein incidence angles of the light rays projecting on the image-side surface of the second lens are lower than about 6.85 degrees.

4. The lens module of claim 1, wherein the anti-reflection film comprises first to fourth layers orderly stacked on the image-side surface, the odd numbered layers of the anti-reflection film are made from titanium dioxide (TiO₂) and the even numbered layers of the anti-reflection film are made from silicon dioxide (SiO₂).

5. The lens module of claim 4, wherein thicknesses of the first to fourth layers are about 11.52 nm, 28.93 nm, 111.15 nm, and 83.78 nm, respectively.

6. The lens module of claim 5, wherein the reflectance of the anti-reflection film is lower than about 2%.

7. The lens module of claim 1, further comprising two spacers, wherein one of the two spacers is positioned between the first lens and the second lens, and the other spacer is positioned between the second lens and the third lens.

8. The lens module of claim 1, further comprising a filter glass covering the image-side end of the lens barrel.
